(19) United States
(12) Patent Application Publication
(10) Pub. No.: US 2026/0217196 A1
(43) Pub. Date: Jul. 30, 2026

(54) MODULAR OVERHEAD STORAGE CONSOLE

(71) Applicant: International Truck Intellectual Property Company, LLC, Lisle, IL (US)

(72) Inventors: Christian Michael Hardin, Wheaton, IL (US); Izza Alejandra Jacobo Ortegon, Troy, MI (US); Marco Antonio de Avila Martinez, Chicago, IL (US); Aditya Rajderkar, Hoffman Estates, IL (US); Ethan Song, Celina, TX (US)

(73) Assignee: International Truck Intellectual Property Company, LLC, Lisle, IL (US)

(21) Appl. No.: 19/039,447

(22) Filed: Jan. 28, 2025

(51) Int. Cl. B60R 7/04

(52) U.S. Cl. CPC B60R 7/04

(57) ABSTRACT

The present disclosure relates to an improved interior overhead storage system for use inside a vehicle. Specifically, the present disclosure relates to a modular overhead storage console for customized installation in a vehicle. The modular overhead storage console includes a base module having mounting attachment/locking mechanisms for connecting various modular components to the base, resulting in highly configurable, customized storage console designs suitable for installation into various vehicles.

### TECHNICAL FIELD

The present disclosure relates generally to an improved interior overhead storage system for use inside a vehicle. Specifically, the present disclosure relates to a modular overhead storage console for installation in a vehicle. The modular overhead storage console includes a base module having mounting attachment/locking mechanisms for connecting various modular components to the base, resulting in highly configurable, customized storage console designs suitable for installation into various vehicles with minimal effort.

### BACKGROUND

Overhead consoles are commonly found in many vehicles. These consoles can enclose electronic controls in vehicles, as well as house various lights including dome lights. Additionally, overhead consoles can be useful for storage for a variety of items, including sunglasses, cell phones, wallets, etc. Given the limits in interior space, storage can be an issue particularly in semi-trucks with and without a sleeper cab.

Various styles of truck cabs can require different console designs and dimensions. These requirements lead to increases in manufacturing complexity, including an increased number of parts, tools, fixtures. Having different designs of overhead consoles requiring separate tools for different truck models (day cab and sleepers) increases overall complexity of assembly execution and negatively impacts costs. Additionally, the lack of common parts and fixtures between various truck cabs can also lead to a lack of utilization of full storage volume of the console, particularly when a console is not designed for optimal space utilization.

Therefore, a need exists for an improved modular overhead storage console configured for assembly into a highly configurable design such that the present modular storage console can be interchangeably incorporated into a variety of vehicle models, reducing manufacturing costs and complexity.

A need also exists for an improved modular overhead storage console comprising a series of modular components, including a base module having an attachment interface compatible for easily connecting additional modular components together creating a customized overhead storage console for the interior of a vehicle.

A need also exists for an improved modular overhead storage console having a base module configurable for installation into a variety of vehicles. The improved modular overhead storage console is compatible for use across a various vehicle models including heavy duty and medium duty vehicles, as interchangeable modules can be added to one another providing highly configurable designs and enabling installation of a customized console.

### SUMMARY

One embodiment of an improved modular overhead storage console comprising a longitudinal frame, at least one bin secured within the frame, a cover disposed over the frame and bin, a series of attachment interfaces on opposing ends of the frame, wherein the attachment interfaces are configured for receiving interchangeable components mountable onto the frame.

Another embodiment of an improved modular overhead storage console comprising a base module, a mounting interface on the base module, wherein the mounting interface is configured for receiving interchangeable components mountable to the base module.

### BRIEF DESCRIPTION OF THE DRAWINGS

FIG. 1 illustrates a perspective view of a base module for the modular overhead storage console of the present disclosure;

FIG. 2 illustrates an exploded view of the base module for the modular overhead storage console of the present disclosure;

FIG. 3 illustrates an exploded view of the base module with the bins assembled for the modular overhead storage console of the present disclosure;

FIG. 4 illustrates a perspective view of a base module including a pair of opposing side bins for the modular overhead storage console of the present disclosure;

FIG. 5 illustrates a perspective view of a base module including side curtain airbag module for the modular overhead storage console of the present disclosure;

FIG. 6 illustrates a perspective view of another embodiment of a modular overhead storage console incorporating upper storage bins of the present disclosure;

FIG. 7 illustrates an exploded view of the modular overhead storage console of FIG. 6;

FIG. 8 illustrates a perspective view of another embodiment of a modular overhead storage console incorporating upper storage bins and upper cubby bins of the present disclosure;

FIG. 9 illustrates an exploded view of the modular overhead storage console of FIG. 8;

FIG. 10 illustrates a front view of the modular overhead storage console of FIG. 8;

FIGS. 11A-11F illustrate a variety of optional door and/or doorless configurations useable in the modular overhead storage console of the present disclosure; and,

FIG. 12 illustrates a curtain track for the modular overhead storage console of the present disclosure.

### DETAILED DESCRIPTION

The present disclosure relates generally to an improved interior overhead storage system for use inside a vehicle. Specifically, the present disclosure relates to a modular overhead storage console for installation in a vehicle. The modular overhead storage console includes a base module having mounting attachment/locking mechanisms for connecting various modular components to the base, resulting in highly configurable, customized storage console designs suitable for installation into various vehicles with minimal effort. The present modular overhead storage console offers a completely modular design which permits customized storage consoles that can be incorporated across a variety of vehicle platforms, leading to reduction in parts, efficient tooling utilization, cost optimization and lower manufacturing complexity and costs. Additionally, the modular overhead storage console of the present disclosure increases the potential storage capacity within a vehicle by over 200 percent from standard overhead storage consoles.

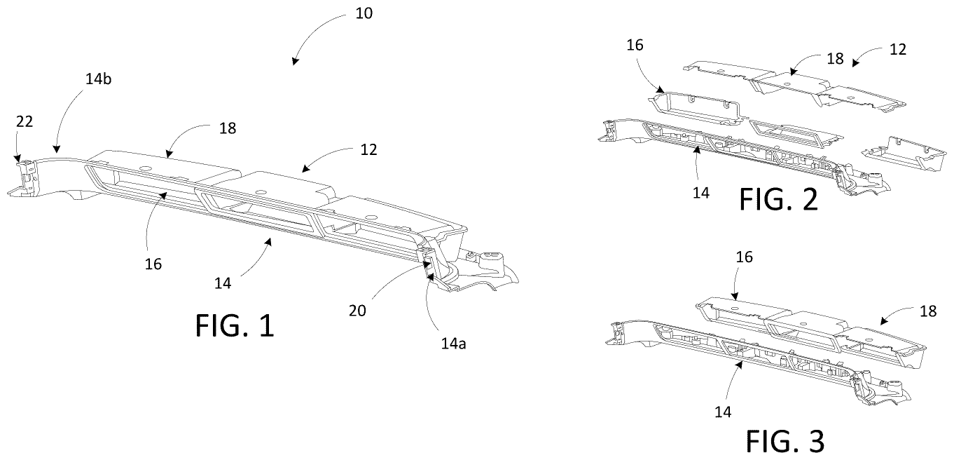

Referring now to FIG. 1, a perspective view of a modular overhead storage console 10 having a base module 12 is shown. Creation of the modular overhead storage console 10 begins with a base module 12, which is configured to receive interchangeable storage components 30. The base module 12 includes a longitudinal frame 14, which is designed to receive a plurality of compartments or bins 16 inserted within the body of the frame. Each compartment of bin 16 can optionally be fitted with a door 17. A cover 18 is fitted and secured over the bins and frame creating enclosures for storage (FIGS. 2-3). This base module 12 provides an initial modular structure adapted for receiving and creating a variety of overhead storage consoles suitable for installing into various vehicle models.

An advantage of the present modular overhead storage console 10 is configured for receiving interchangeable storage components or bins 30, which are mountable onto the frame 14, and to other bins building on the base module 12 to create a customized console. In particular, the interchangeable, modular feature of the overhead storage console 10 enables the console to be built and customized to fit into various styles of vehicle cabs. Additionally, because of the base module 12 being the same across the console embodiments, the modular overhead storage console 10 can be installed within the interior of a vehicle using the same common attachment points (not shown).

The base module 12 includes a first attachment interface 20 on a first end 14a of the frame, and a second attachment interface 22 on an opposing second end 14b of the frame. As shown in FIG. 1-3, the first attachment interface 20 may be a projection or pin, while the second attachment interface 22 is an opening or recess configured for receiving the projection. Each attachment interface 20,22 is configured for receiving a corresponding attachment interface on the interchangeable components 30.

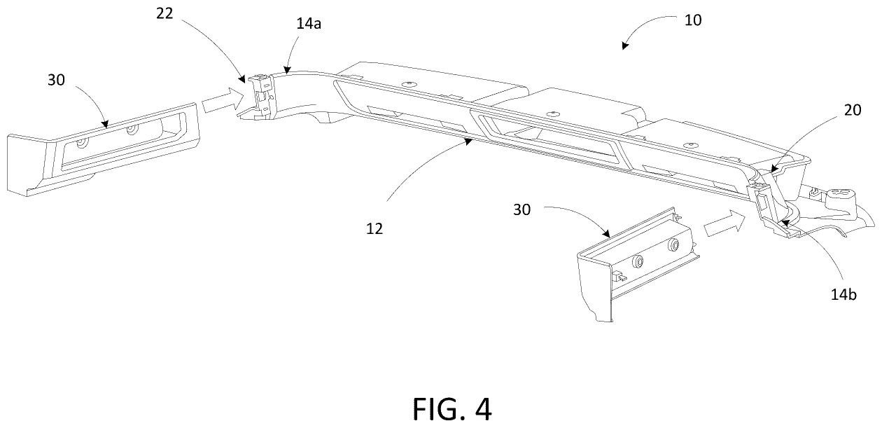

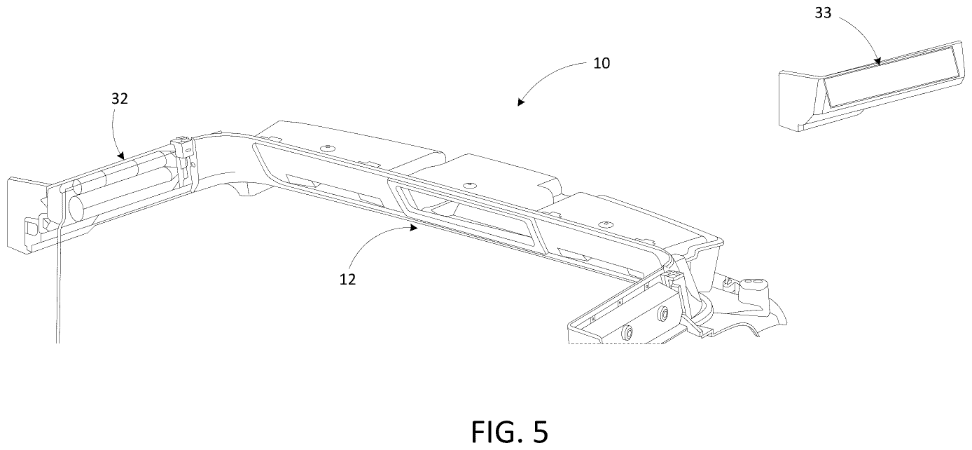

For example, FIG. 4 illustrates modular overhead storage console 10 having two, opposing side bins 30, one on the driver side and one on the passenger side, which are attached to the respective ends 14a, 14b of the frame 14. Engagement of the first and second attachment interfaces 20,22 on the frame interlocks the two side bins 30 onto the frame, creating additional storage to the console 10. Optionally, one or more of the side bins 30 may be replaced with a side curtain airbag module 32, as shown in in FIG. 5. Rather than a storage bin, the side curtain airbag module 32 containing the airbag would be covered by a closed fascia 33 designed to release the airbag, as necessary.

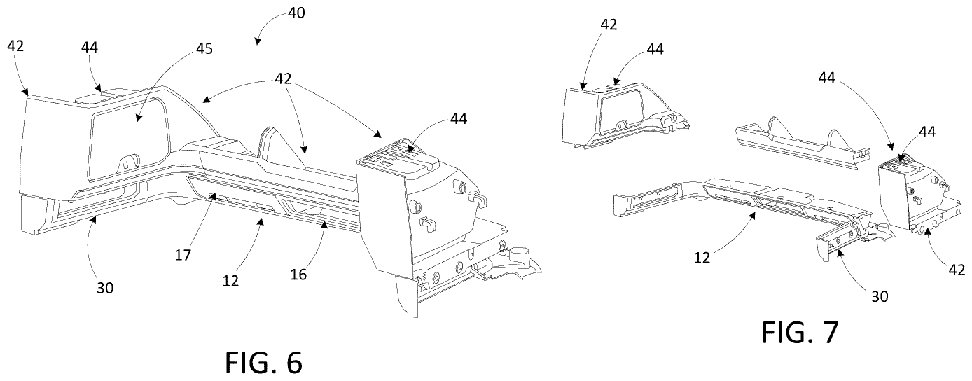

FIGS. 6-9 represent additional embodiments of the modular overhead storage consoles according to the present disclosure. These modular overhead storage consoles 40, 50 are generally larger than the previous modular overhead storage console 10, as it incorporates additional storage bins, such as upper storage bins 42 and additional upper storage cubbies 52, respectively. These larger modular overhear storage consoles 40, 50, are typically useful in vehicle cabs with larger interior spaces, such as a sleeper cab of a semi-trailer truck.

Creating the modular overhead storage console 40, 50 begins with the same base module 12 provided in the earlier modular overhead storage console 10. As provided in FIG. 4, the opposing side bins 30 are secured to the frame 14 of the base module through the first attachment interface 20 on a first end 14a of the frame, and the second attachment interface 22 on an opposing second end 14b of the frame. As shown in FIGS. 6 and 7, and building upon the base module 12, upper storage bins 42 can then be attached to the top surface of each of the opposing side bins 30 utilizing mounting interfaces. The upper storage bins 42 include a door 45 creating closed compartment storage.

Building upon the base module 12, the upper storage bin 42 includes a first mounting interface 43 on a bottom surface of the upper storage bin. The first mounting interface 43 is compatible for engagement with a second mounting interface 33 the top of the side bin 30. The first mounting interface 43 may be in the form of protrusions on an underside of the upper storage bins 42 that slide or wedge into corresponding receivers on the upper surface of the side bins 30 in a press-fit configuration. In this manner, additional storage is created utilizing the base module 12 and common interlocking bins 30, 42.

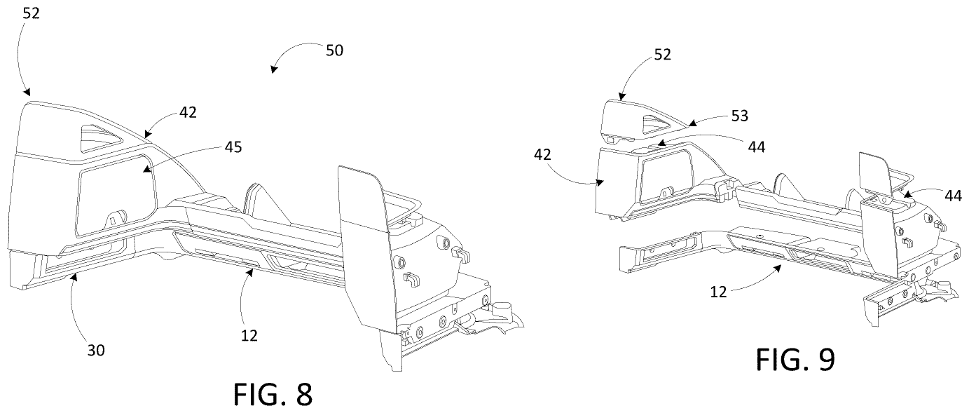

FIGS. 8 and 9 illustrate yet another embodiment of a modular overhead storage console 50 according to the present disclosure. This particular console 50 is a further extension of the module 40 described above, providing additional storage options within a larger vehicle cab. Building upon the upper storage bin 42 of FIGS. 6 and 7, an upper cubby bin 52 is added on top of the upper storage bin. The upper cubby bin 52 includes a first mounting interface 53 on a bottom surface of the upper cubby bin, which is compatible for engagement with a corresponding receiver 44 on the top surface of the upper storage bin 42 in a sliding or interlocking configuration. Addition of the upper cubby bin 52 provides additional storage to the modular overhead storage console 50 on both the drive and passenger sides of the vehicle.

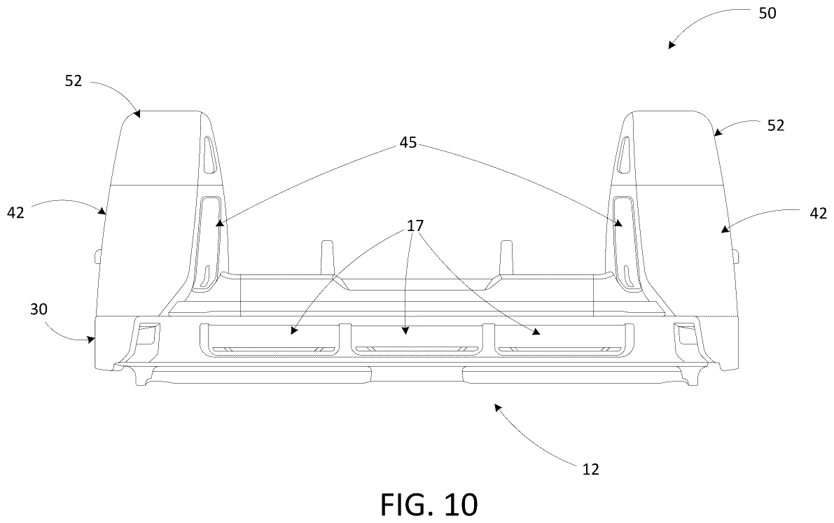

FIG. 10 illustrates a front view of the modular overhead storage console 50, as the console would be placed within a vehicle for access to both the driver and passenger. The overhead storage console 50 includes a plurality of front doors 17 over the compartments 16 within the base module 12, as well as doors 45 on the upper storage bins 42, providing secure storage for various items.

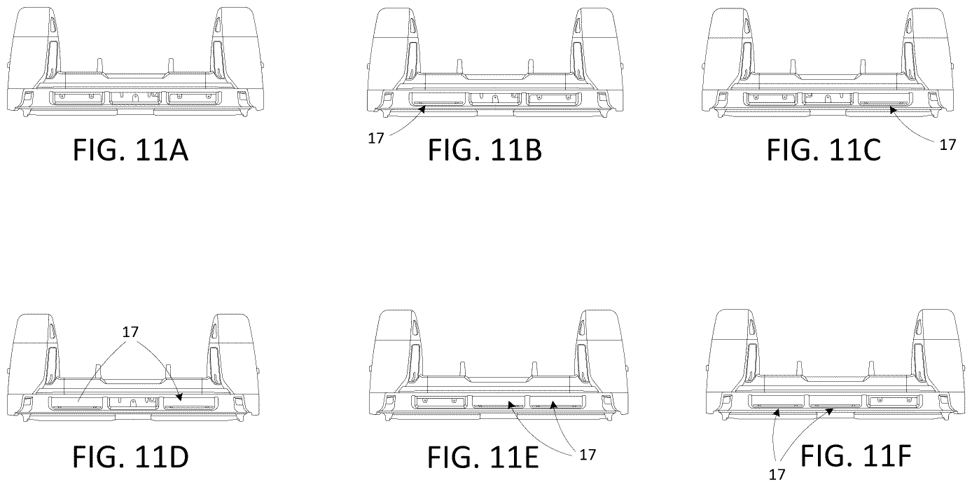

FIGS. 11A-11F illustrate various door options for the modular overhead storage console 50. While a larger modular overhead storage console 50 embodiment is illustrated, it should be understood that various door/no door options are compatible with every console embodiment of the present disclosure. FIG. 11A illustrates a doorless option with open access to the interior of each compartment 16. Optionally, the compartments may be covered by a softer covering, such as a netting, rather than a solid door. FIGS. 11B and 11C illustrate a single door option, with one door 17 on either the left-hand compartment 16 or right-hand compartment 16 of the console 50, while the remaining compartments remain open and doorless. FIGS. 11D, 11E and 11F each illustrate various two-door optional configurations on the compartments 16, with one open/doorless compartment.

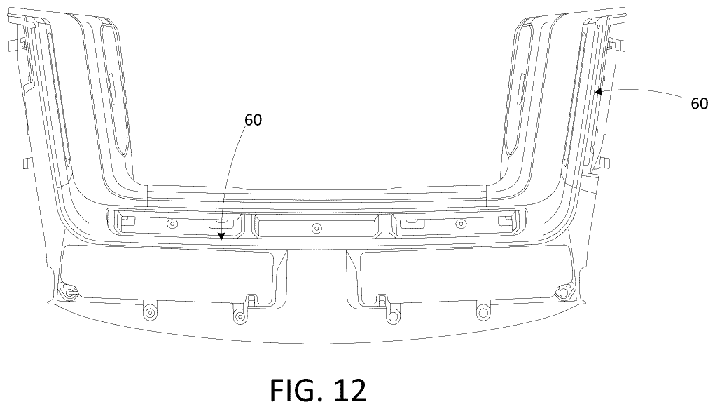

FIG. 12 illustrates an embodiment of a modular overhead storage console according to the present disclosure incorporating a curtain track 60 having a groove profile. The curtain track 60 may run along the entire length of a particular modular overhead storage console. Curtains are often incorporated into vehicles with sleeping compartments.

The embodiments of the present modular overhead storage consoles 10, 40, 50 offer numerous advantages including ease of assembly, customization, and utility across various vehicle models. Additionally, the present modular overhead storage console also provides compatible mounting interface options between the base module and the various storage compartments or bins, wherein the storage bins can easily be added to the base module creating unique and useful storage units compatible for a wide variety of vehicles. The modular overhead storage consoles of the present disclosure can increase the storage capacity by over 200 percent from previous storage options.

We claim:

1. A modular overhead storage console comprising:
a longitudinal frame;
at least one bin secured within the frame;
a cover disposed over the bin and frame;
a series of attachment interfaces on opposing ends of the frame;
wherein the attachment interfaces are configured for receiving interchangeable components mountable onto the frame.

2. The modular overhead storage console of claim 1, wherein the series of attachment interfaces includes a first attachment interface on a first end of the frame and a second attachment interface on an opposing second end of the frame.

3. The modular overhead storage console of claim 2 wherein the first attachment interface comprises a projection on the first end of the frame.

4. The modular overhead storage console of claim 2, wherein the second attachment interface comprises a recess on the second opposing end of the frame.

5. The modular overhead storage console of claim 3, wherein the projection on the first end of the frame is compatible with an attachment interface on the interchangeable components.

6. The modular overhead storage console of claim 4, wherein the recess on the second opposing end of the frame is compatible with an attachment interface on the interchangeable components.

7. The modular overhead storage console of claim 1, wherein the interchangeable components are bins.

8. The modular overhead storage console of claim 7, wherein the bins are configured for storage.

9. The modular overhead storage console of claim 1, wherein the interchangeable components are side curtain airbag modules.

10. A modular overhead storage console for a vehicle comprising:
a base module;
at least one mounting interface on the base module;
wherein the mounting interface is configured for receiving interchangeable components mountable onto the base module.

11. The modular overhead storage console of claim 10, wherein the base module further includes a frame configured for enclosing a series of compartments.

12. The modular overhead storage console of claim 10, wherein each of the interchangeable components is configured for attachment to the mounting interface.

13. The modular overhead storage console of claim 12, wherein the interchangeable components are storage bins.

14. The modular overhead storage console of claim 13, wherein the storage bins include mounting interfaces configured for engagement with the mounting interface of the base module.

15. The modular overhead storage console of claim 14, wherein a plurality of storage bins are attached onto the mounting interface of the base module.
